(19) United States
(12) Patent Application Publication
(10) Pub. No.: US 2024/0013157 A1
(43) Pub. Date: Jan. 11, 2024

(54) WELLNESS PROGRAM

(71) Applicant: Goomi Group Inc., Menifee, CA (US)

(72) Inventor: Mika Leah Daniels, Irvine, CA (US)

(21) Appl. No.: 18/350,609

(22) Filed: Jul. 11, 2023

Related U.S. Application Data
(60) Provisional application No. 63/388,172, filed on Jul. 11, 2022.

(51) Int. Cl. G06Q 10/1057; G06Q 10/1093; G06Q 40/08

(52) U.S. Cl. CPC G06Q 10/1057; G06Q 10/1095; G06Q 40/08

(57) ABSTRACT

A wellness program that enables an employer and an insurance carrier to collaborate to offer health and wellness programs to employees that include classes from service providers. The wellness program receives employee information, service provider information, class information, and stores the information in a database. The program then generates a calendar of events that includes the classes offered by the service providers. Insurance carriers are signed up and provided access to the calendar, along with the employees. Employees are then able to sign up for the classes. Funds from the insurance carrier are used to pay for the classes taken by the employees.

### CROSS-REFERENCE TO RELATED APPLICATIONS

This application for a utility patent claims the benefit of U.S. Provisional Application No. 63/388,172, filed Jul. 11, 2022.

### BACKGROUND OF THE INVENTION

### Field of the Invention

This invention relates generally to fitness and wellness programs, and more particularly to a wellness program that enables an employer to administer the program for its employees with cooperation with insurance companies and brokers.

### Description of Related Art

It is known in the prior art to provide a wellness program in a company for the benefit of it's employees. Such wellness programs enable employees to access various fitness and health programs offered by the employer, for the long term health of the employees, which results in increased productivity and fewer sick days.

While insurance carriers typically support such programs, they have little to no say in the administration of such programs, and there is little to no transparency for verifying the success of the programs. The present invention provides a wellness program that enables an employer to administer the program for its employees with cooperation with insurance carriers and brokers, in a manner that is fully transparent to all stakeholders of the program. The wellness program also enables the administrators of the program to provide a marketplace of services, provided by various service providers (e.g., trainers, fitness experts, dieticians, etc.). The wellness program of the present invention fulfills these needs and provides further advantages as described in the following summary.

### SUMMARY OF THE INVENTION

The present invention teaches certain benefits in construction and use which give rise to the objectives described below.

The present invention provides a wellness program that enables an employer and an insurance carrier to collaborate to offer health and wellness programs to employees that include classes from service providers. The wellness program receives employee information about employees of an employer, and stores the employee information in the database. It also receives service provider information and stores the service provider information in the database, and receives class information about classes offered by the service providers, and stores the information in the database. The program generates a calendar of events that includes the classes offered by the service providers; populates the calendar of events with the classes stored in the database; receives insurance carrier information and stores the insurance carrier information in the database; provides access to the calendar, and the classes offered, to the employees and the insurance carrier; receives requests from the employees to sign up for the classes offered in the calendar; receives funds from the insurance carrier; and transfers funds provided by the insurance carrier to the service providers in exchange for the service providers providing the classes offered on the calendar to the employees who signed up for these classes.

A primary objective of the present invention is to provide a wellness program having advantages not taught by the prior art.

Another objective is to provide a wellness program that enables an employer to administer the program for its employees with cooperation with insurance carriers and brokers, in a manner that is fully transparent to all stakeholders of the program.

A further objective is to provide a wellness program that provides a marketplace of services provided by various service providers (e.g., trainers, fitness experts, dieticians, etc.), and accessible by the employees, which may be paid, in whole or in part, by the insurance carriers and/or the employer.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a block diagram of one embodiment of a computer system that operates a wellness program that embodies the present invention;

FIG. 2 is a flow diagram illustrating the operation of the wellness program;

FIG. 3 is a screen capture of one embodiment of a survey generated by the wellness program;

FIG. 4 is a screen capture of a main client page having a calendar in list view, the main page further having a suggestion banner generated by an algorithm of the wellness program;

FIG. 5 is a screen capture of an engagement stats screen, illustrating a list of classes that have been scheduled; and

FIG. 6 is a screen capture of a wellness offering screen, showing a selection of expandable classes options to schedule for employees.

FIG. 7 is a screen capture of a calendar of the wellness program, illustrating an invite broker/carrier option.

### DETAILED DESCRIPTION OF THE INVENTION

The above-described drawing figures illustrate the invention, a wellness program that uses a computer system to provide various classes to employees for enhancing group health and productivity. In particular, the wellness program enables an employer and an insurance carrier to collaborate to offer health and wellness programs to employees that include classes from service providers, and that are customized to the needs of each individual office of the employer.

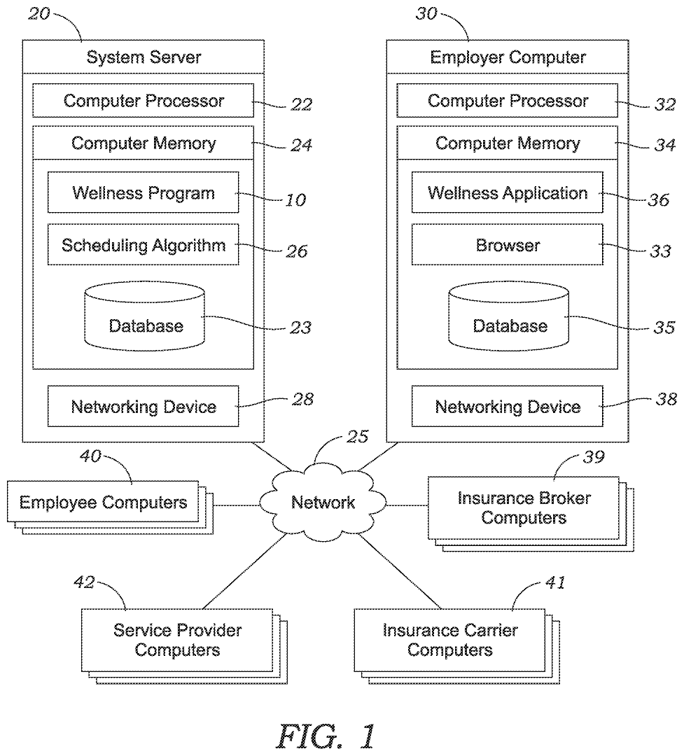

FIG. 1 is a block diagram of one embodiment of a computer system that operates a wellness program 10 of the present invention. As shown in FIG. 1, a computer system in this embodiment includes a system server 20 that operates the wellness program 10 and a corporate computer 30 operated by a representative of the employer (e.g., the human resources department, or other department or group that is tasked with this responsibility), which is able to interact with the system server 20 to customize the operation of the wellness program 10 for the benefit of its employees and/or other persons.

As shown in FIG. 1, each of the system server 20 and the corporate computer 30 includes a computer processor 22 and 32 and a computer memory 24 and 34, respectively, and may include a bus or equivalent structure that couples various system components including the computer processor 22, 32 to the computer memory 24, 34. For purposes of this application, as discussed below, any element mentioned in the singular also includes the plural, so it is to be understood that the term “computer processor” also includes multiple processors, and the term “computer memory” includes multiple memory devices, and either of which may be configured in any manner known in the art (i.e., in a single device, or distributed in any manner known to those skilled in the art).

As shown in FIG. 1, the computer memory of the system server 20 stores executable code that, when executed, runs a process for providing the wellness program 10 to employees of an employer. The executable code of the computer memory includes the wellness program 10 and a scheduling algorithm 26, each discussed in depth below, and further includes a database 23. Furthermore, the system includes a networking device 28 that communicates with a networking device 38 of the corporate computer 30 via a network 25.

In this embodiment, the computer memory of the corporate computer 30 may include a wellness application 36 which may be in the form of a downloadable program, and/or it may also include a browser 33 which may be used for accessing the software via the Internet or equivalent network. The system server 20 may further include a database 35 for storing data, as discussed in greater detail below.

As illustrated in FIG. 1, in some embodiments, the networking devices 28 and 38 may further enable communication with employee computers 40 and service provider computers 42 via the network 25, also discussed further below.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The terms “computer,” “computer device,” and “server” as used herein, refers to a device and/or system of devices that include at least one computer processing element, e.g., a central processing unit (CPU), and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM. FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The network may include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 2G, 3G, 4G, and future access networks may enable wide area coverage for mobile devices. In essence, the wireless network may include any wireless communication mechanism known in the art by which information may travel between computers of the present system.

The term “corporation,” or similar terms such as “company,” “organization,” etc. as used herein refers to any individual, organization (e.g. corporation, LLC, and so on), nonprofit, or other form of human organization, and/or a computer functioning on behalf of the corporation that is seeking use of the program 10.

The term “employee” as used herein, refers to any individuals, or computer functioning on behalf of the individual that works for or is associated with the employer, including any independent contractors, volunteers, or temporary workers who may benefit from the wellness program 10.

Various embodiments now will be described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, devices, or any similar or equivalent arrangements known to those skilled in the art. Accordingly, the various embodiments may take the form of an entirely hardware embodiment, an entirely software embodiment or an embodiment combining software and hardware aspects. The following detailed description is, therefore, not to be taken in a limiting sense.

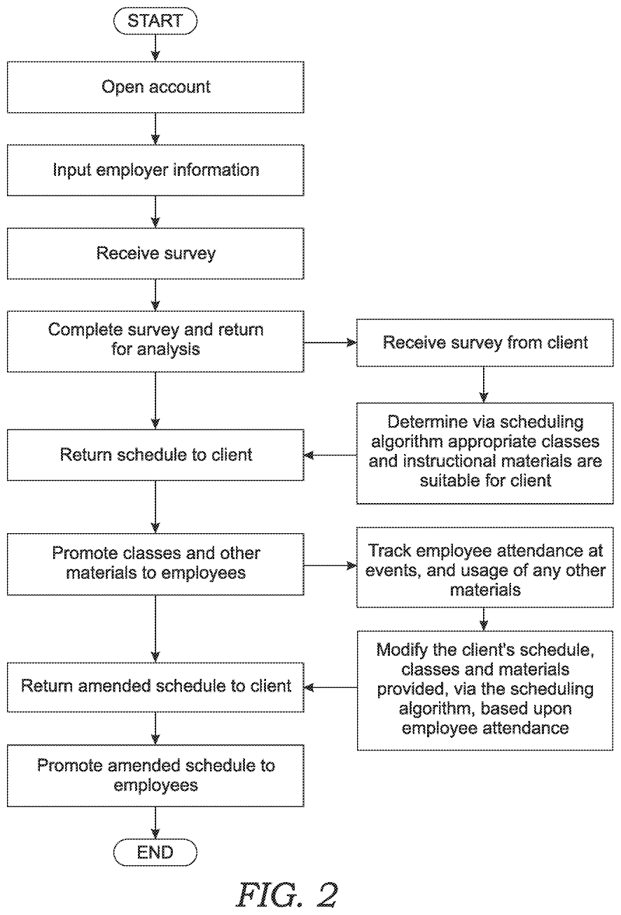

FIG. 2 is a flow diagram illustrating the operation of the wellness program 10. As shown in FIG. 2, in this embodiment, at a first step of the operation of the wellness program 10 a corporate administrator opens an account using the corporate computer 30 that communicates with the system server 20 to display the wellness application 36, either on the browser 33, or via downloadable application (“app”) on a personal mobile device. The corporate administrator may be any individual or group authorized to operate the wellness program 10 and oversee its operation, e.g., an office manager, consultant, etc. The corporate administrator inputs information about the employer, such as the number of employees, geographic location(s), contact information, etc., or any other corporate information that may be useful to the scheduling algorithm 26 as discussed below.

At this step of the operation, the administrator may also be prompted to select a package or subscription including some or all of the features included in the wellness program 10. This may be tiered based on size of employer, and the combination of features provided may be any selection of features, as determined by the programmers. In some embodiments, the wellness program 10 may be adapted to communicate with a benefits broker or insurance carrier to facilitate payment.

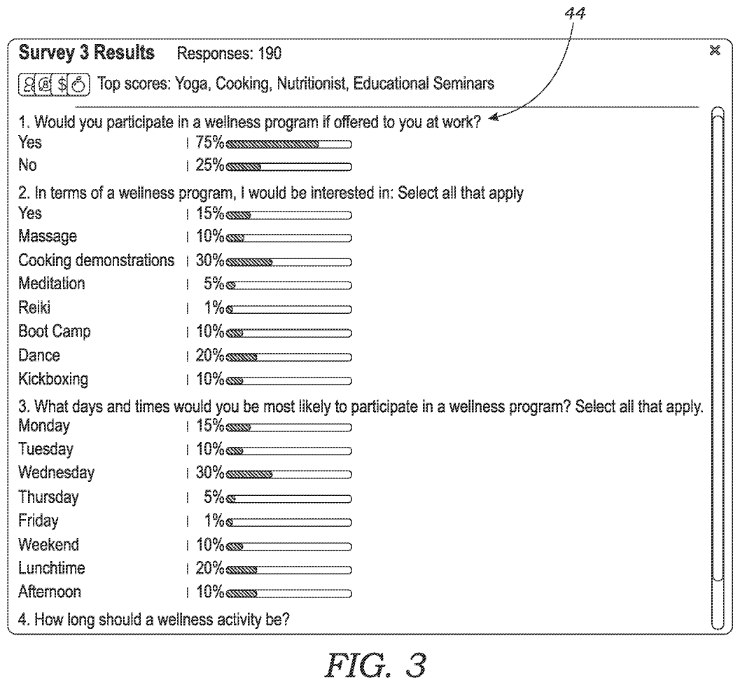

At a next step of the operation, a survey (an example of which is shown in FIG. 3) is sent to employees of the company, in this embodiment via the network to the employee computers 40, but any means may be used to transmit the survey, e.g., it may be printed and filled out by hand, or recorded by an individual asking employees verbally, etc. Questions on the survey are intended to determine which aspects of the program 10 are desired for that particular employer's employees, e.g., features for stress reduction, team-building, exercise, etc., which may vary between different clients. One embodiment of some of the questions asked by the survey are shown in FIG. 3 and discussed in detail below.

Once the survey is completed, it is returned for analysis. The system server 20 receives the survey results and determines via the scheduling algorithm 26 the appropriate classes and instructional materials that are suitable for the client, and creates a schedule that is transmitted back to the corporate computer 30. The corporate computer 30 receives the schedule and returns it to the corporate administrator, who may then have the option to promote/market the classes and materials to employees either via the network to the employee computers 40, or by another means, e.g., physical bulletin, company email, etc., or any other suitable communication method. The recommended schedule could include events/classes/seminars/courses/etc., which may be related to a wide variety of topics, e.g., yoga, meditation, a sound bath, dance class, health fair, massage, cardio class, etc., or any other suitable health-related topics.

In various implementations of the present invention, the system server 20 may communicate with the service provider computers 42 of FIG. 1, to engage services for events/classes/seminars/courses/etc. The service providers may be given a flat fee to provide these services, or have another agreement with the program 10. The service provider(s) and/or the corporate administrator(s) and/or the automated scheduling algorithm 26 may send marketing to the employee base, either via a wireless message, bulletin, in-person discussion, or such that the employee accesses the application 36 on his or her personal device.

At a next step of the operation, as the promoted schedule is followed by the employees, the wellness program 10 tracks employee attendance at events/classes, and their usage of materials. In some embodiments, and individual or individuals of the company may be able to submit further feedback, or other metrics may be tracked, as deemed suitable by those skilled in the art. The scheduling algorithm 26 of the system server 20 receives this data and uses it to modify the schedule, and classes and materials provided, and then transmits a new amended schedule to the corporate computer 30, which then repeats the previous step.

FIG. 3 is a screen capture of one embodiment of a survey 44 generated by the wellness program 10. As shown in FIG. 3, the operation of the wellness program 10 includes the step of sending a survey to the client and receiving the completed survey to determine a schedule for the client. As shown in FIG. 3, in this embodiment, the survey may include questions in various categories that are calculated to then display which categories received the highest favor from the survey participants. In this example the top-scoring categories are Yoga, Cooking, Nutritionist, and Educational Seminars. Some of the related survey questions include: Would you participate in a wellness program if offered to you at work? In terms of a wellness program, I would be interested in: Select all that apply. Other questions may be more oriented toward scheduling rather than category of interest. Some illustrated examples include: What days and times would you be most likely to participate in a wellness program?Select all that apply. How long should a wellness activity be?

Obviously, these example survey questions are intended only to enable the program 10 10 through illustration, and are not meant to be taken in a limiting sense. There may be any number of questions, greater or fewer than shown, and concerning any relevant information that the program 10 may use to enhance feedback to the client. As shown in FIG. 3, the survey response page may be viewed by the corporate administrator as well as transmitted to the system server 20 so the scheduling algorithm 26 may return a schedule to the client.

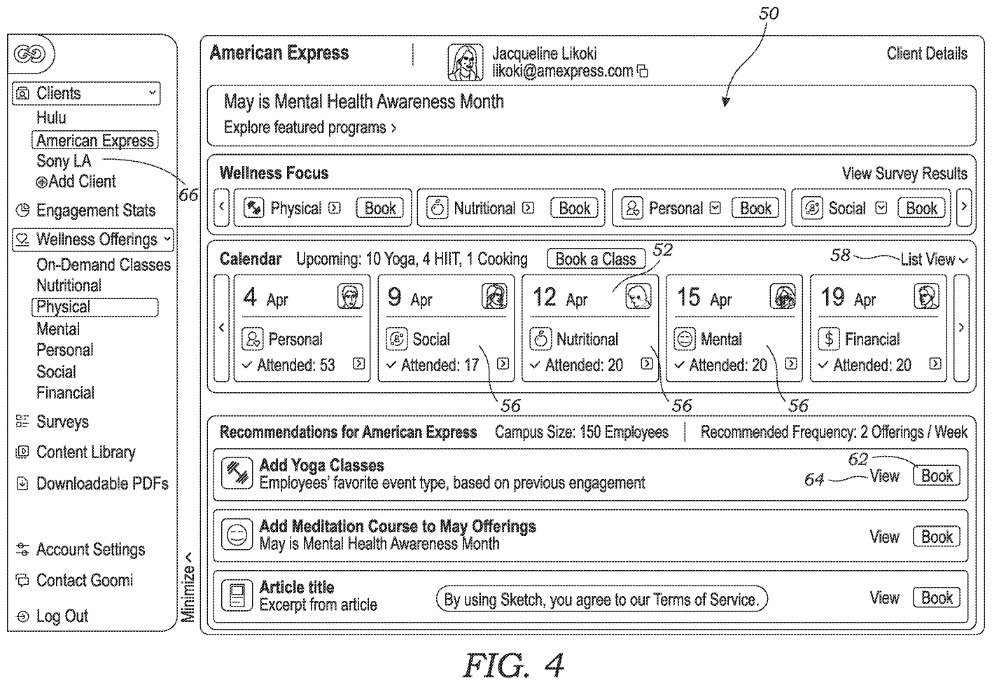

FIG. 4 is a screen capture of a main client page 50 having a calendar 52 in list view, the main client page 50 further having a suggestion banner 54 generated by the scheduling algorithm 26 of the system server 20. As shown in FIG. 4, in this embodiment, the corporate administrator may log in the already-created account of the wellness application 36 using the browser 33 of the corporate computer 30, and navigate to the main client page 50.

In this embodiment, the corporate administrator may be authorized to make changes on multiple corporate accounts as shown, or in other cases just one main client page 50 will be accessible.

The main client page 50 may include the calendar 52, which shows previous classes/events on days 56 of a week/month, which may include various information such as the category of class/event (as with the survey 44), and the number of people who attended or RSVP'd to the class/event, image of the instructor, etc., or any other information desired to be shown on the days 56. The calendar 52 may further include a drop-down button 58 that allows the user to change to a grid view (not shown), or any other desired view. In some embodiments, a further option to “market” the event/class/etc. may be provided (not shown), to promote each event/class/etc. to the employee base.

As shown in FIG. 4, the main client page 50 further includes the suggestion banner 54 generated by the scheduling algorithm 26. The suggestion banner 54 may include a list of suggestions that may be in the form of a class, course, reading, or any other related suggestions. A booking button 62 may be provided to add a suggestion to the calendar 52, and there may further be a button 64 for viewing more details about each suggestion. As illustrated, the suggestion banner 54 may include additional information such as the recommended frequency of calendar events, or why each suggestion is provided, i.e., based on previous engagement, survey results, etc. In some operations, the suggestion banner 54 may update in real-time as the corporate administrator selects a schedule, receives feedback, etc.

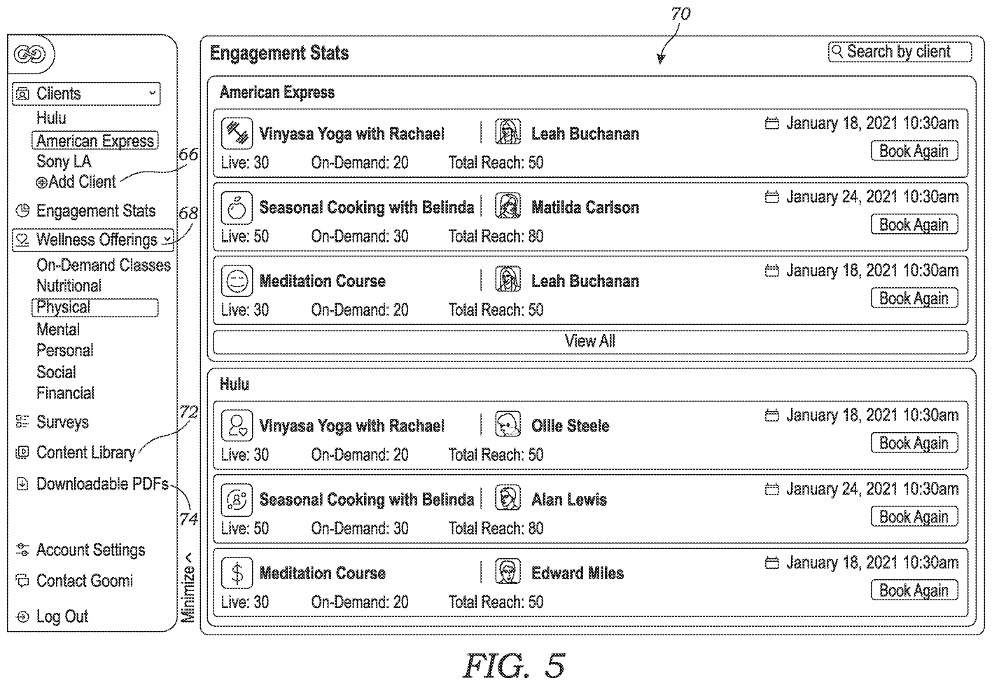

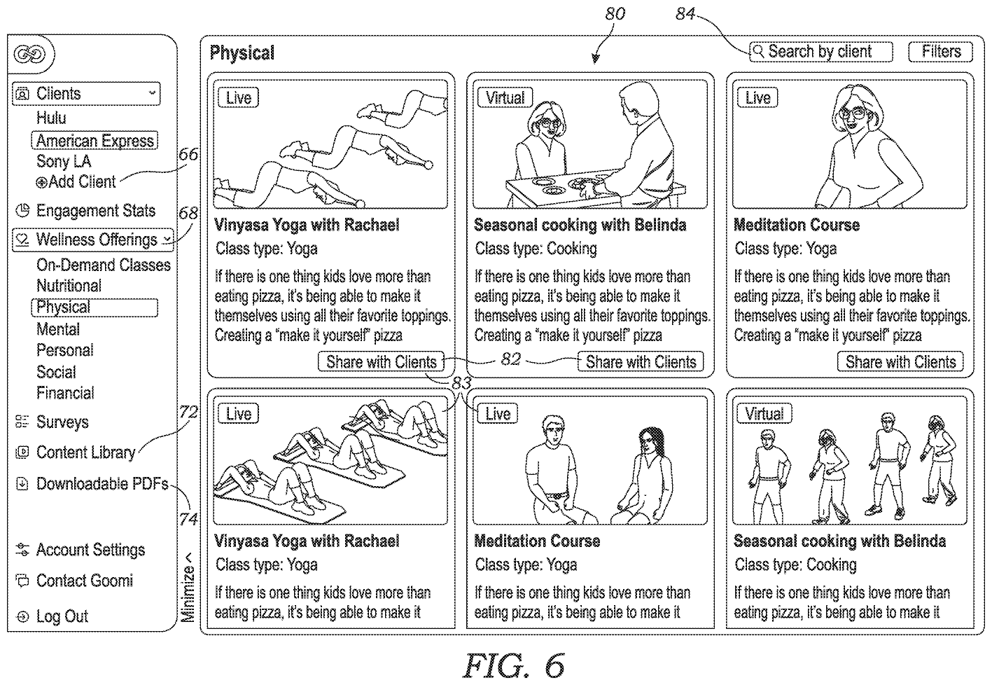

In some embodiments, the wellness application 36 may include a navigation column 66, which may be collapsible, that allows the user to navigate the application 36. In this embodiment, the navigation column 66 includes a link to an engagement stats page 70, as shown and discussed in FIG. 5, and a wellness offerings drop-down menu 68 where each category of provided services/events may be explored, as shown and discussed in FIG. 6. In some embodiments, the navigation column 66 further includes links to the survey 44 of FIG. 3, a content library 72, and a downloadable PDFs page 74. The content library (not shown) may include content such as articles, blogs, etc., that supplement the classes and events of the wellness program 10. In some embodiments, there may be an option to buy the entire content library (not shown). The downloadable PDFs page (not shown) may include content such as white papers, case studies, etc., that are relevant to the wellness program 10.

As illustrated, other options may be provided within the navigation column 66, or elsewhere within various pages of the application 36, such as links to a settings page and a contact/support page, log out button, etc., as is well-known in the art.

FIG. 5 is a screen capture of the engagement stats page 70, illustrating a list 76 of classes that have been scheduled. As shown in FIG. 5, in this embodiment, the engagement stats page 70 comprises the list 76 or other means of viewing the history of completed events/classes/etc., and further shows various metrics such as how many signed up versus attended, how many heard about the event/course/etc., or any other information that may be relevant to future event planning. As illustrated, a “book again” button 78 may be provided so that the corporate administrator may view the metrics shown in the history 76 and decide to repeat events/classes/etc. based upon these metrics. In some embodiments, a further option to “market” the event/class/etc. may be provided (not shown), to promote each event/class/etc. to the employee base.

FIG. 6 is a screen capture of a wellness offerings page 80. As shown in FIG. 6, the drop-down menu 68 may include links to various wellness offerings pages, in this embodiment being for an on-demand classes page, and a page for each category of health metric (a.k.a., “vertical”). In this embodiment, the categories are physical, nutritional, mental, financial, social, and personal. As examples, the physical category may include options such as cardio classes, etc., nutritional may include cooking classes, etc., mental category may include counseling, etc., financial may include financial literacy classes, etc., social may include group-bonding exercises, etc., and personal may include a presentation on heart disease prevention, etc. Possible classes/seminars/activities/etc. provided are not limited to these examples, and have infinite potential for different services provided in each category. Furthermore, in some embodiments, the categories may be different from those described herein.

As shown in FIG. 6, the wellness offerings page 80 is showing classes options 83 related to the “physical” health metric, e.g., the classes options 83 may include cooking, yoga, meditation, etc., and may include any relevant details such as name of instructor, summary of course, whether it is in person, streamed/live, or pre-recorded, etc. Other types of classes/courses/events may be provided, and those shown are intended only as an example. In this embodiment, each class option 83 is expandable so the user may view any additional details when selected. In some embodiments, each class option 83 further includes a button 82 for sharing or marketing the class with the employee base as discussed above. As shown in FIG. 6, in this embodiment, the wellness offering page 80 further includes a search bar 84 so the user may search a catalogue from each health metric.

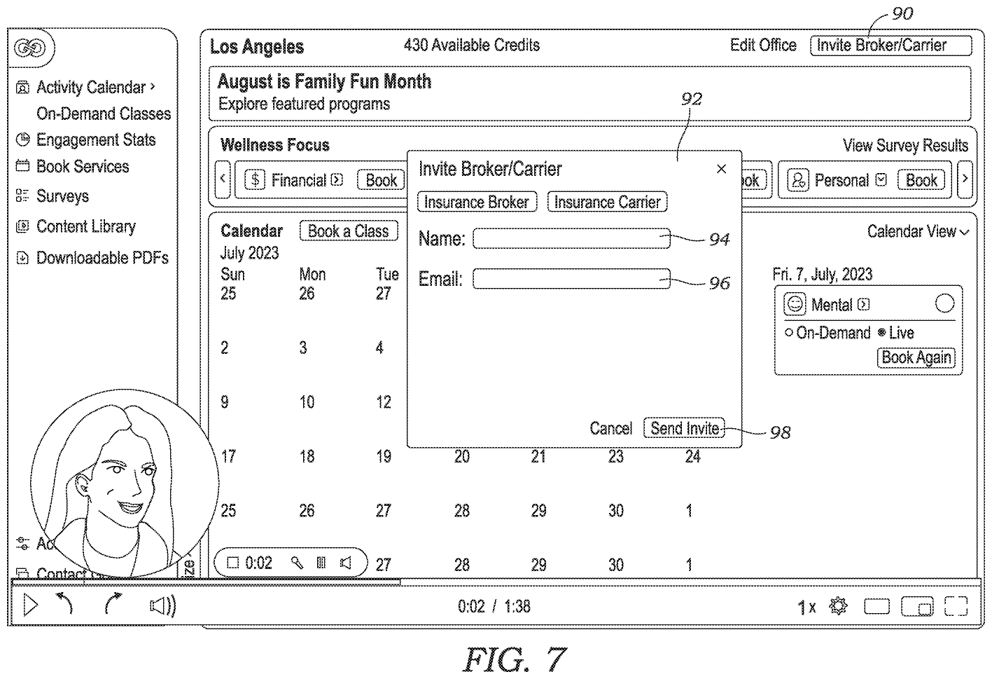

FIG. 7 is a screen capture of a calendar of the wellness program, illustrating an invite broker/carrier option which includes an invite broker/carrier button 90. Upon actuation of the invite broker/carrier button 90, an invite broker/carrier dialog box 92 is opened, which includes a name box 94, an email box 96, and/or any other contact information that may be desired. A send invite 98 button may be used to submit the form, thereby causing an invitation to be sent to the broker/carrier to enable them to sign up for access to the program 10. This process may include setting up a payment method (e.g., linking a bank account, entering a credit card, etc.), enabling the broker/carrier to transfer funds to the program 10 and to also access the program 10 for purposes of monitoring the progress of the program 10 and overseeing its success.

Once funds have been transferred into an account associated with the program 10, these funds may be utilized for the payment of invoices generated by the service providers for services provided to the system 10. For example, the insurance carrier might provide a $10,000 payment to promote the health and general fitness of the employees (to reduce future insurance costs), and these funds may be then paid out to service providers, such as yoga instructors, personal trainers, and other fitness experts provided by the program 10, for the classes they provide to employees.

The program 10 also provides access to the insurance carrier (and/or broker) so that they may monitor the implementation of the fitness program, and monitor employee engagement and use of the various classes provided, and make sure the funds are being spend, and utilized correctly. This level of access and transparency is not available using prior art systems, and provides a superior level of access, review, and control. This also enables the insurance carrier to add additional funding if required and merited, or to revoke funds that are not used correctly.

A wellness program that enables an employer and an insurance carrier to collaborate to offer health and wellness programs to employees that include classes from service providers. The wellness program receives employee information, service provider information, class information, and stores the information in a database. The program then generates a calendar of events (examples of which are shown in FIGS. 4 and 7) that includes the classes offered by the service providers. Insurance carriers are signed up and provided access to the calendar, along with the employees. Employees are then able to sign up for the classes. Funds from the insurance carrier are used to pay for the classes taken by the employees.

The calendar may be uniquely customized to each office of an employer. For example, a large corporate employer may have offices in multiple major cities (Los Angeles, New York, San Francisco, etc.), and these cities may have very different needs in the classes offered. While one set of classes may be offered in Los Angeles, and be very popular for this location, an entirely different set of classes may be better suited for the New York office. These classes are determined by the scheduling algorithm 26 (shown in FIG. 1), with particular reference to surveys such as shown in FIG. 3. Other factors include how many employees sign up, and who actually attend the classes. Attendance may be tracked by the service providers for live classes, or by the program 10 for recorded classes that are downloadable or streamed.

It should be understood that the web pages and/or app screens illustrated herein are merely exemplary embodiments, and those skilled in the art may devise many alternative web pages, or include additional options (e.g., settings, profile, history, etc.) in a sidebar or in an alternative screen, as is well-known in the art. While certain embodiments of web pages are illustrated, the system 10 should not be limited to this disclosure, but should be construed to include alternative embodiments which may be designed by one skilled in the art.

The system server 20 may include one or more servers, desktop computers, multiprocessor systems, microprocessor-based or programmable electronics devices, network appliances, or any form of equivalent device(s) known in the art. The system computer may be in the form of a single device, or multiple devices. The system server 20 may be distributed over a plurality of network devices and/or implemented using cloud architecture. The system server 20 may operate using a master/slave approach over a plurality of network devices, within a cluster, a peer-to-peer architecture, and/or any of a variety of other architectures.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A wellness program that enables an employer and an insurance carrier to collaborate to offer health and wellness programs to employees that include classes from service providers, and that are customized to the needs of each individual office of the employer, the wellness program comprising:
one or more computer devices and computer memory, the computer memory storing executable code that, when executed, enables the computer system to perform a process that comprises:
providing a database;
receiving employee information about employees of an employer, and storing the employee information in the database;
receiving service provider information and storing the service provider information in the database;
receiving class information about classes offered by the service providers, and storing the class information in the database;
receiving insurance carrier information and storing the insurance carrier information in the database;
providing a calendar of events;
populating the calendar of events with the classes offered by the service providers that are stored in the database;
providing access to the calendar, and the classes offered, to the employer, the employees, and the insurance carrier;
receiving requests from the employees to sign up for the classes offered in the calendar;
receiving funds from the insurance carrier; and
transferring funds provided by the insurance carrier to the service providers in exchange for the service providers providing the classes offered on the calendar to the employees who signed up for these classes.

2. The wellness program of claim 1, wherein the main client page further includes a suggestion banner generated by a scheduling algorithm.

3. The wellness program of claim 1, wherein the classes include yoga, meditation, and fitness classes.

4. The wellness program of claim 1, wherein the classes include instruction in nutrition and cooking.

5. The wellness program of claim 1, wherein the calendar is uniquely customized to each office of an employer.
